(19) United States
(12) Patent Application Publication
(10) Pub. No.: US 2020/0019910 A1
(43) Pub. Date: Jan. 16, 2020

(54) BLOCK-BASED PREDICTION FOR MANUFACTURING ENVIRONMENTS

(71) Applicant: Applied Materials, Inc., Santa Clara, CA (US)

(72) Inventor: David Everton NORMAN, Bountiful, UT (US)

(21) Appl. No.: 16/412,121

(22) Filed: May 14, 2019

Related U.S. Application Data
(60) Provisional application No. 62/697,214, filed on Jul. 12, 2018.

(51) Int. Cl. G06Q 10/06

(52) U.S. Cl. CPC G06Q 10/06375; G06Q 10/06311; G06Q 10/0633

(57) ABSTRACT

Embodiments presented herein provide techniques for executing a block-based (BB) workflow to generate predictions related to a semiconductor manufacturing environment. Embodiments include receiving at least one BB workflow comprising a plurality of blocks. The plurality of blocks may specify a set of operations for generating the predictions for a specified future time interval. Embodiments include accessing a plurality of block definitions corresponding to the plurality of blocks. Embodiments include executing the at least one BB workflow by performing the set of operations based on the plurality of block definitions, including extracting data from the semiconductor manufacturing environment, the data comprising both static data and dynamic data related to equipment in the manufacturing environment, determining, based on the extracted data, the predictions related to the manufacturing environment for the specified future time interval, and publishing the predictions to at least one component in the semiconductor manufacturing environment.

### RELATED APPLICATIONS

This application claims the benefit of U.S. Provisional Application No. 62/697,214, entitled “BLOCK-BASED PREDICTION FOR MANUFACTURING ENVIRONMENTS,” by the same inventors, filed 12 Jul. 2018 (Attorney Docket No.: 44015558US01), the contents of which are incorporated herein in their entirety.

### BACKGROUND

### Field

Embodiments of the present disclosure generally relate to prediction, and more particularly to techniques for predicting future states of equipment and lots in manufacturing environments, using block-based workflows.

### Description of the Related Art

Manufacturing facilities across many different industries are responsible for producing products that are used in every facet of life. In the case of semiconductor manufacturing, for example, semiconductor manufacturing facilities manufacture products such as, microprocessors, memory chips, microcontrollers, and other semiconductor devices that have a ubiquitous presence in everyday life. These semiconductor devices are used in a wide variety of applications, examples of which include automobiles, computers, home appliances, cellular phones, and many others. Further, in recent years, both the number of applications and demand for devices (including semiconductor devices) has steadily increased. This increased demand has led manufacturing facilities to become increasingly conscious of increasing product variety and reducing delivery times.

Each manufacturing environment is unique and extremely complex, often requiring immense amounts of capital for the necessary equipment, tools, facilities, etc. Because manufacturing is so capital intensive, even small increases in factory performance (e.g., such as building to demand, shortening order to delivery time, etc.) can have large effects on financial performance (e.g., by reducing cost through leaner manufacturing, freeing up capital tied to idle inventory, etc.). For this reason, many manufacturing facilities have recently become interested in implementing scheduling and dispatching systems in their facilities to manage the complexity, provide high-quality, on-time deliveries, etc.

Scheduling and dispatching in a manufacturing facility involve making complicated decisions about what operations should be performed and the order of these operations. In order to generate a schedule for a manufacturing facility, prediction models are sometimes used to predict future states of systems and lots in the manufacturing facility. Creating prediction models requires gathering data from a variety of systems, processing the data into a form that can be used for predictions, and publishing predictions within the manufacturing facility. Existing techniques for creating prediction models require the use of custom code. Custom code, however, can be difficult to maintain and inflexible, which makes it difficult to make modifications. In many cases, for example, the manufacturing facility may undergo changes to account for new applications, tool improvements, etc. With prediction models that are created using custom code, however, adapting to such changes can require a level of technical expertise that may not be available to the manufacturing facility (e.g., an end user may not have coding experience, etc.), require a significant time commitment, substantial costs (e.g., due to the complexity of the facility), etc.

### SUMMARY

Embodiments disclosed herein include methods, systems, and computer program products for block-based (BB) prediction in a manufacturing environment. In one embodiment, a method for executing a block-based (BB) workflow to generate a plurality of predictions related to a semiconductor manufacturing environment is disclosed. The method includes: receiving at least one BB workflow comprising a plurality of blocks, wherein the plurality of blocks specify a set of operations for generating the prediction for a specified future time interval; accessing a plurality of block definitions corresponding to the plurality of blocks; and executing the at least one BB workflow by performing the set of operations based on the plurality of block definitions, comprising: extracting data from the semiconductor manufacturing environment, wherein the data comprises both static data and dynamic data related to equipment in the manufacturing environment; determining, based on the extracted data, the plurality of predictions related to the manufacturing environment for the specified future time interval; and publishing the plurality of predictions to at least one component in the semiconductor manufacturing environment, wherein the plurality of predictions are used to determine a manufacturing schedule for the semiconductor manufacturing environment.

Another embodiment provides a non-transitory computer-readable medium containing computer program code that, when executed, performs an operation for executing a block-based (BB) workflow to generate a prediction related to a semiconductor manufacturing environment is disclosed. The operation includes: receiving at least one BB workflow comprising a plurality of blocks, wherein the plurality of blocks specify a set of operations for generating the prediction for a specified future time interval; accessing a plurality of block definitions corresponding to the plurality of blocks; and executing the at least one BB workflow by performing the set of operations based on the plurality of block definitions, comprising: extracting data from the semiconductor manufacturing environment, wherein the data comprises both static data and dynamic data related to equipment in the manufacturing environment; determining, based on the extracted data, the plurality of predictions related to the manufacturing environment for the specified future time interval; and publishing the plurality of predictions to at least one component in the semiconductor manufacturing environment, wherein the plurality of predictions are used to determine a manufacturing schedule for the semiconductor manufacturing environment.

Still another embodiment provides a system comprising at least one processor and a memory containing a program that, when executed by the at least one processor, performs an operation for executing a block-based (BB) workflow to generate a prediction related to a semiconductor manufacturing environment is disclosed. The operation includes: receiving at least one BB workflow comprising a plurality of blocks, wherein the plurality of blocks specify a set of operations for generating the prediction for a specified future time interval; accessing a plurality of block definitions corresponding to the plurality of blocks; and executing the at least one BB workflow by performing the set of operations based on the plurality of block definitions, comprising: extracting data from the semiconductor manufacturing environment, wherein the data comprises both static data and dynamic data related to equipment in the manufacturing environment; determining, based on the extracted data, the plurality of predictions related to the manufacturing environment for the specified future time interval; and publishing the plurality of predictions to at least one component in the semiconductor manufacturing environment, wherein the plurality of predictions are used to determine a manufacturing schedule for the semiconductor manufacturing environment.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a block diagram of an architecture of a manufacturing environment configured with a block-based prediction component, in accordance with embodiments of the present disclosure.

FIG. 2 illustrates a block diagram of an architecture of a block-based prediction component within a manufacturing environment, in accordance with embodiments of the present disclosure.

FIG. 3 illustrates an interface with a block-based workflow for predicting a future state of equipment and lots in a manufacturing environment, in accordance with embodiments of the present disclosure.

FIG. 4 illustrates an example block properties panel that can be used to configure a set of operations to be performed for a particular block in a BB workflow, according to one embodiment.

FIG. 5 is a flow diagram illustrating a method for predicting a future state of equipment and lots in a manufacturing environment, in accordance with embodiments of the present disclosure.

FIG. 6 is a flow diagram illustrating another method for predicting a future state of equipment and lots in a manufacturing environment, in accordance with embodiments of the present disclosure.

FIG. 7 illustrates a computing system configured with a block-based prediction component, in accordance with embodiments of the present disclosure.

To facilitate understanding, identical reference numerals have been used, wherever possible, to designate identical elements that are common to the Figures. Additionally, it is contemplated that elements disclosed in one embodiment may be beneficially used in other embodiments described herein without specific recitation.

### DETAILED DESCRIPTION

Embodiments presented herein present techniques for predicting future states of equipment and lots in a manufacturing environment, using block-based workflows. The workflows can be used by an end-user to construct a prediction system that predicts future states of equipment and/or lots in a manufacturing environment, and the predictions may be used for scheduling and dispatching within the manufacturing environment. For example, each workflow contains an order of a series of operations (e.g., represented by one or more blocks of the workflow) that are performed in order to generate one or more predictions. Examples of these operations can include retrieving data from different sources, manipulating and transforming the data into different formats, analyzing the data, generating predictions based on the data, manipulating and transforming the predictions into different formats, providing or publishing the predictions to multiple outputs, etc. By arranging and/or modifying blocks within the workflow, an end-user (e.g., of a manufacturing environment) can adapt the prediction system to account for any change to the manufacturing environment, without having specialized programming knowledge or writing complicated scripting and code.

Today, manufacturing facilities have very complex environments in which facilities typically perform several different tasks related to the manufacture of a product. These tasks can include, but are not limited to, tasks for servicing tools (or equipment) within the manufacturing environment, tasks for using manufacturing tools, tasks for changing a tool setup, tasks for inspecting a manufacturing tool, tasks for performing one or more processes on resources (or an unfinished product) in order to manufacture a completed product, etc. In the case of semiconductor manufacturing, the semiconductor manufacturing process is generally divided into two parts, “front-end” and “back-end,” both of which use different types of semiconductor manufacturing equipment. Front-end typically refers to wafer fabrication. For example, front-end manufacturing facilities generally start with blank semiconductor wafers (e.g., silicon wafers) and perform various processes, such as photolithography, deposition, etching, cleaning, ion implantation, chemical and mechanical polishing, etc., to fabricate a completed wafer with many semiconductor die on the wafer. Back-end typically refers to the assembly and testing of individual semiconductors. For example, once the front-end production process is completed, the completed wafers are transferred to a back-end manufacturing facility, which typically performs functions such as dicing the completed wafer into individual semiconductor die, testing, assembly, packaging etc. As such, front-end and back-end processes can consist of hundreds of processing steps performed by several different tools or automated devices within the manufacturing environment. To meet the ever increasing demand for manufacturing products, it is becoming increasingly important for manufacturing environments to schedule the series of complex tasks performed within the manufacturing environment and/or control the tools (or groups of tools) and automated devices within the manufacturing environment. Furthermore, in many cases, dispatching is also performed to determine which tasks to perform at a given time. Dispatching often involves decisions such as whether to start processing a batch that has fewer lots than allowed, or to wait to start the batch until another lot is available so a full batch can be started.

In order to perform scheduling and dispatching in manufacturing environments, prediction models are sometimes used to generate predictions related to the manufacturing environment, such as predictions regarding future states of equipment and/or lots (e.g., when a lot will be available for processing) in the manufacturing environment. In many cases, prediction models have to be modified to account for changes in the manufacturing cycle (e.g., a change in the process flow, changes to processing times, different tool groups, new tools introduced, and the like) problems within the manufacturing environment (e.g., tool failures, defects in the output product, maintenance operations, and the like), new incoming orders, changes to orders, etc. Keeping prediction models configured and maintained using existing techniques involves modifying custom code. This can involve complicated scripting and code to be written by a user with specialized programming knowledge, involve a significant amount of time, decreased productivity, etc.

As will be described in more detail below, embodiments provide techniques that can be used to define and configure prediction processes that are open, configurable and extensible by the end user (e.g., of a manufacturing facility) through the use of block-based workflows. For example, an end-user can use the techniques presented herein to extend the workflow (e.g., to include additional steps, etc.), adjust processing order of a workflow, configure (or customize) the set of operations within the workflow, etc., all without the need to understand or write any code. As such, the prediction system presented herein provides manufacturing facilities with the ability to configure and maintain prediction processes despite changing circumstances and without requiring specialized programming knowledge, or difficult and time-consuming operations that are associated with conventional techniques.

One embodiment includes a method for executing, by a block-based (BB) prediction component, at least one BB workflow to generate a prediction related to a manufacturing environment (e.g., front-end or back-end semiconductor facility or factory). Within the manufacturing environment, several tools (or equipment) can be available for processing raw material or a work-in-progress (e.g., unfinished goods) to produce a completed product. For example, in semiconductor manufacturing, one or more tools can be used to process one or more lots during front-end processing, back-end processing, etc. For front-end, the one or more lots generally refer to one or more blank semiconductor wafers. For back-end, the one or more lots generally refer to one or more semiconductor die (e.g., on completed semiconductor wafers).

In one embodiment, the BB prediction component allows for the generation of predictions about the future state of a manufacturing facility and its components. The predictions generated may specify, for example, a future state of the equipment and/or lots in the manufacturing facility, the quantity and composition of the product that will be manufactured in the facility, the state of the operators (e.g., their location, whether they are working or idle), the estimated time a product will finish a given operation and/or be available for processing at a given step, the estimated time a preventative maintenance operation should be performed on equipment, etc. To generate the prediction, the BB prediction component can extract data from the manufacturing environment. The data can include static data (e.g., equipment used by a source system, capability of different pieces of the equipment, etc.) and dynamic data (e.g., current equipment state, products being currently processed by equipment of a source system, the product characteristics, etc.). The BB prediction component may use the data to generate predictions. For example, the BB prediction component may generate the predictions using a technique specified in a BB workflow (e.g., using simulation, forecasting, statistical prediction, trend analysis, machine learning, queuing theory, or calculations). The BB prediction component can publish the determined predictions to at least one device or component (e.g., to perform scheduling/dispatching in the manufacturing environment, etc.).

In one embodiment, the BB prediction component performs each of the above operations based on various blocks within a BB workflow. Each block of the BB workflow specifies one or more operations of the set of operations that the BB prediction component performs when the BB prediction component executes the workflow. Using the techniques presented herein, a user can edit and/or customize the sequence of operations (that are executed by the BB prediction component) by changing the order of the blocks in the BB workflow, adding/removing blocks in the BB workflow, adding/removing links (e.g., representing data flow) between blocks in the BB workflow, etc. For example, a user may generate and/or edit the BB workflow via a user interface that supports drag-and-drop input. Further, the techniques presented herein also allow a user to configure some or all of the operations within one or more blocks of the BB workflow with one or more BB rules and reports. For example, upon executing one or more blocks in the BB workflow, the BB prediction component may further evaluate at least one BB sub-rule or report configured for the respective workflow block in order to perform the operations specified by the workflow block. Doing so in this manner provides manufacturing facilities the ability to edit, and customize (e.g., without understanding or writing code) prediction operations to account for any changes in the manufacturing facility. BB reports, rules, and sub-rules can be created by a user and allow the user to configure, without the need to understand or write any code, the operations for each block in the BB workflow(s). In this manner, the techniques presented herein allow the user to customize the operations for the blocks in the prediction workflow that may be used to extract data, convert the data, and/or perform error checking.

Note that, for the sake of convenience, terminology related the manufacture of semiconductor devices is used in much of the following description as a reference example of a manufacturing production process that can be scheduled based on predictions generated using the techniques presented herein. Similarly, many of the following embodiments use front-end and back-end semiconductor manufacturing facilities as reference examples of types of manufacturing environments in which the techniques presented herein can be used to provide a prediction system that is open, extensible, and fully configurable by an end-user. Note, however, that the techniques presented herein can also be applied to other types of manufacturing environments (e.g., in other industries), manufacturing processes, etc.

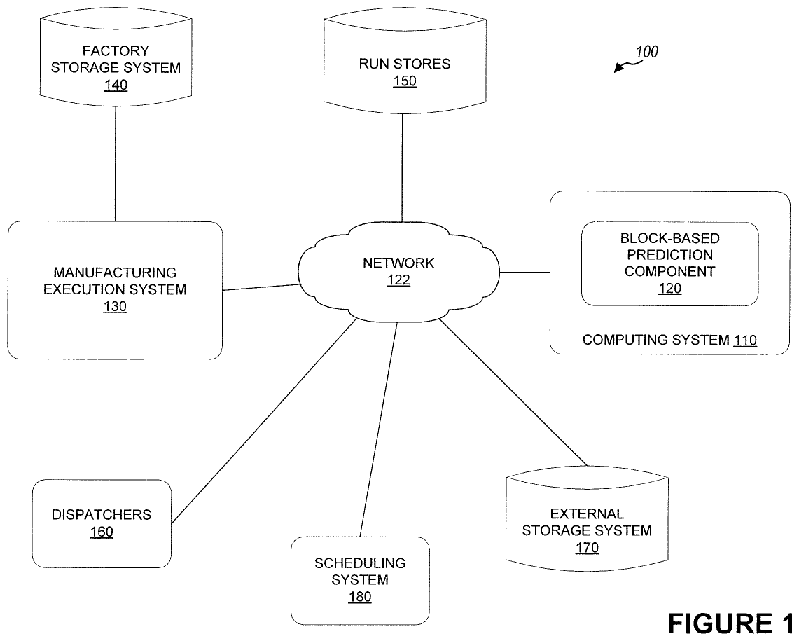

FIG. 1 is a block diagram illustrating an architecture of a manufacturing environment (or system) 100, in which aspects of the present disclosure may be practiced. For example, in one embodiment, the manufacturing environment 100 is an example of a semiconductor manufacturing system. As shown, the manufacturing environment 100 includes a computing system 110, manufacturing execution system (MES) 130, factory storage system 140, dispatchers 160, run stores 150 and external storage system 170 connected via a network 122. In general, the network 122 can be a wide area network (WAN), local area network (LAN), wireless LAN (WLAN), etc. The factory storage system 140, external storage system 170 and run stores 150, in general, can be any kind of storage system, including, for example, relational and/or hierarchal databases, distributed filing systems, etc. In one embodiment, the computing system 110, MES 130, and dispatchers 160 can be any kind of physical computing system having a network interface, such as a desktop computer, laptop computer, mobile device, tablet computer, server computing systems, gateway computers, and the like.

The MES 130 is generally configured to manage and control the operation of a current work-in-progress (WIP) within the manufacturing environment 100. For example, the MES 130 can monitor the operation of one or more tools (or equipment) operating in the manufacturing environment 100, receive data directly from the tools, analyze data from the tools, and/or collect the data. In one embodiment, the MES 130 can store the data (received from the tools) into factory storage system 140. Such information stored in the factory storage system 140 can include information regarding the current WIP, current tool state, manufacturing data, etc.

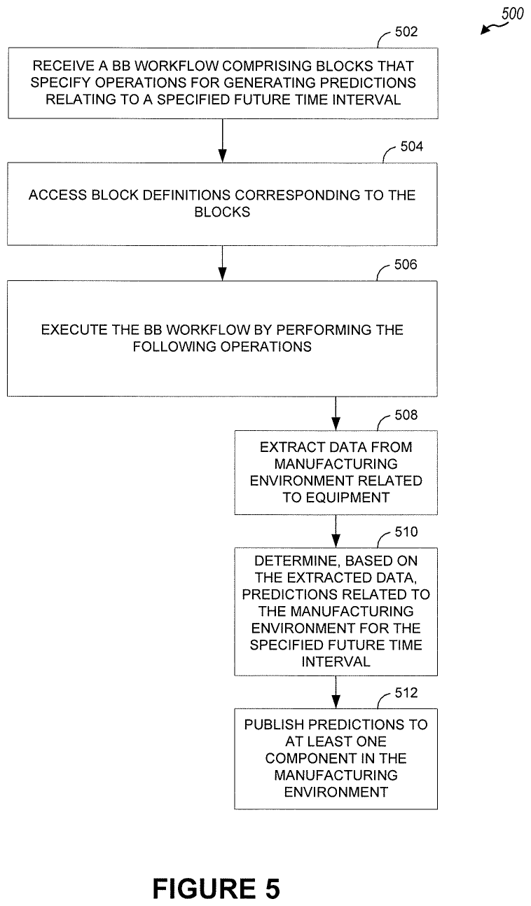

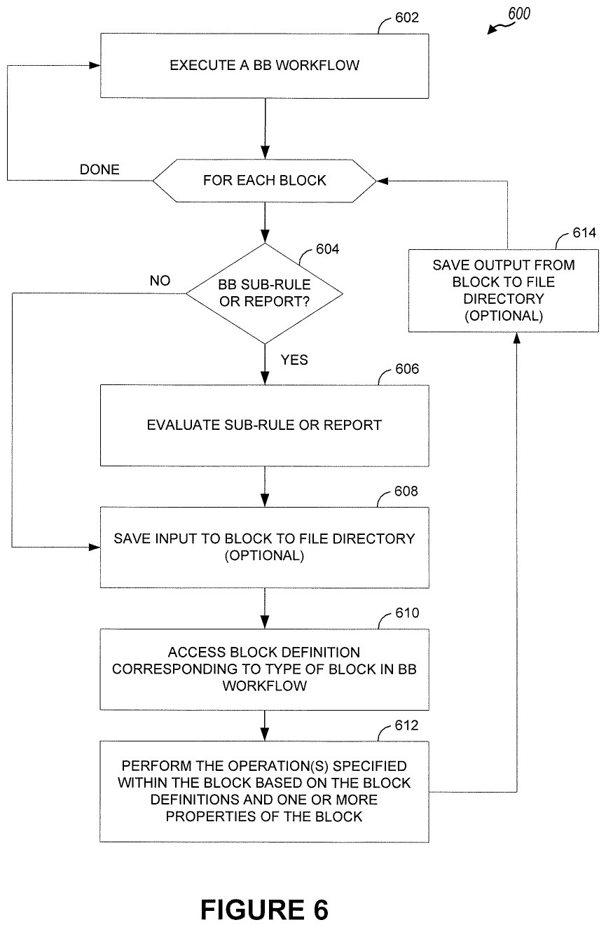

As shown, the computing system 110 includes BB prediction component 120. The BB prediction component 120 generally represents logic (e.g., a software application, device firmware, an ASIC, etc.) that is configured to implement one or more of the techniques presented herein. For example, the BB prediction component 120 could perform method 500 illustrated in FIG. 5, method 600 illustrated in FIG. 6, and/or any of the techniques (or combination of techniques) described herein. In one embodiment, the BB prediction component 120 generates predictions related to the manufacturing environment 100 by executing a BB workflow defined by a user (e.g., via a user interface). For example, in the case of semiconductor manufacturing, the manufacturing system can perform several different tasks related to the fabrication of semiconductor wafers (e.g., associated with front-end processing), cutting, assembly, and testing of semiconductor die on the wafers (e.g., associated with back-end processing), and the like. The BB prediction component 120 may retrieve data from the manufacturing environment 100, such as from the MES 130 and other devices/components (e.g., a material control system (MCS) and/or other tools). In one embodiment, the BB prediction component 120 calculates predictions using one or more formulas based on the data (which may first be transformed or converted into an appropriate format for use in prediction determinations). For example, the BB prediction component 120 can process the data to generate predictions by making calculations, forecasting, statistical prediction, trend analysis, machine learning, running simulation, or using any other technique. The BB prediction component 120 may determine a technique for generating predictions based on a preference identified by the user in the BB workflow. The generated predictions may be converted into a format compatible with at least one other component (e.g., a scheduling component, which may also be located on computing system 110 or one a separate system) or device, and then may be published to the at least one other component or device. For example, the predictions may be published to one or more of dispatchers 160, which may, for instance, automate one or more devices within the manufacturing environment based on the predictions. In some embodiments, predictions are used by dispatchers 160 to determine tasks or operations that should be performed next.

In some cases, the manufacturing system may have a large number of lots that need to be processed. To manage the processing, scheduling system 180 may periodically generate schedules (e.g., every five minutes, ten minutes, or some other configurable time period) based on the predictions to allocate some or all of the lots to available tools, sequence the lots, etc. For example, the schedule can include a list of which tasks should be processed on which tool and at what time. In one embodiment, a schedule is generated by scheduling system 180 based on the predictions and is then provided to dispatchers 160, which are generally configured to dispatch (e.g., according to the schedule) the lots to the tools for processing. For example, dispatchers 160 may automate the one or more devices within the manufacturing environment according to the generated schedule. Alternatively or additionally, predictions and/or schedules may be written (or saved) by the BB prediction component 120, scheduling system 180, or another component to an external storage system 170. Maintaining the predictions and/or schedules in the external storage system 170 allows the predictions and/or schedules to be made available to different entities.

In one embodiment, the BB prediction component 120 is configured to execute one or more BB workflows in order to generate a prediction. The BB prediction component 120 can receive a workflow (e.g., created by an end-user via a user interface) that includes a plurality of blocks where each block in the workflow specifies one or more operations that are performed when the BB prediction component 120 executes the respective block. This workflow can be more easily edited and/or customized (e.g., by a user) without any specialized programming knowledge, relative to conventional scripting solutions. For example, the user can re-arrange the blocks in the workflow (e.g., to adjust the steps that the BB prediction component 120 performs when generating a prediction), add blocks to the workflow (e.g., to add steps that the BB prediction component 120 performs when generating a prediction), and/or remove blocks from the workflow (e.g., to remove steps that the BB prediction component 120 performs when generating a prediction). As described below, the user can also configure the specific operations for one or more blocks in the workflow with a BB sub-rule and/or report. Doing so in this manner provides a fully configurable prediction system that allows manufacturing systems to adapt their prediction systems, as needed, without the complexities involved in modifying custom code.

In one embodiment, the BB prediction component 120 is configured to write, for each prediction run, some or all the input and/or output data associated with the blocks of the workflow to the run stores 150. This data captures the state of the manufacturing system at one or more steps of a prediction run, such that, in the event there is a problem with a generated prediction, the manufacturing system can reproduce the problem since all data needed to reproduce what occurred is available in run stores 150. In this manner, the manufacturing system can troubleshoot any problems by retrospectively debugging the system.

Note, however, that FIG. 1 illustrates merely one possible arrangement of the manufacturing environment 100. More generally, one of ordinary skill in the art will recognize that other embodiments of manufacturing systems can also be configured to implement predictions in accordance with the techniques presented herein. For example, although the computing system 110, MES 130 and dispatchers 160 are shown as separate entities, in other embodiments, these components could be included as part of one computing system.

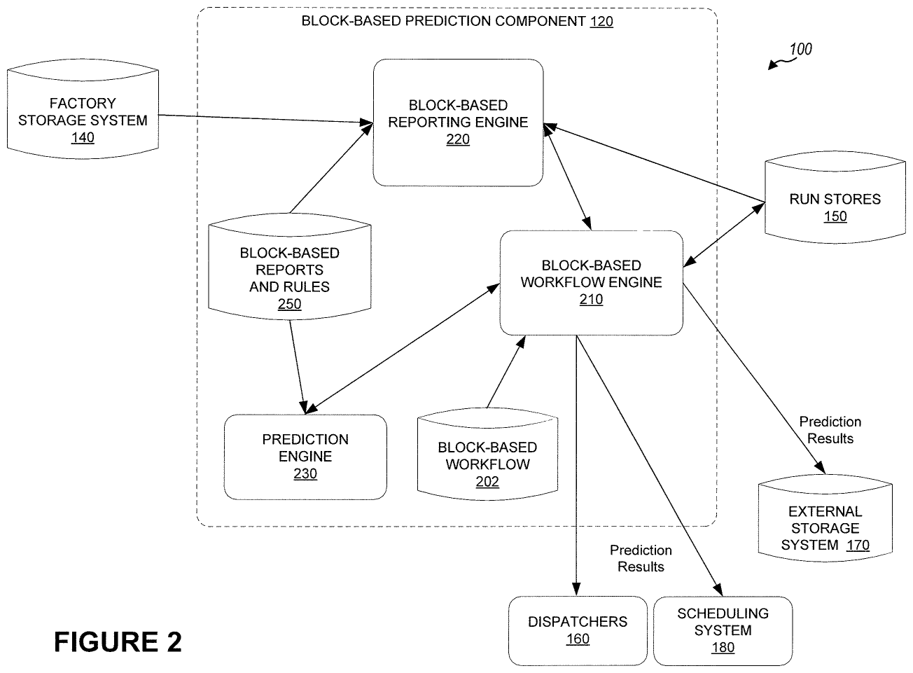

FIG. 2 further illustrates an example of the BB prediction component 120 described relative to FIG. 1, according to one embodiment. The BB prediction component 120 is configured to generate a prediction related to the manufacturing environment 100 and its components. For example, the prediction (generated by the BB prediction component 120) may specify a future state of the equipment and/or lots in the manufacturing facility, the quantity and composition of the product that will be manufactured in the facility, the state of the operators (e.g., their location, whether they are working or idle), the estimated time a product will finish a given operation and/or be available for processing at a given step, the estimated time a preventative maintenance operation should be performed on equipment, etc. As mentioned above, the product can refer to one or more lots of semiconductor wafers (e.g., for front end), partially finished semiconductor wafers, one or more semiconductor die (e.g., for back-end), etc.

As shown, the BB prediction component 120 includes a BB workflow engine 210, a BB reporting engine 220, a prediction engine 230, BB reports and rules (RR) storage system 250, and a BB workflow storage system (e.g., database) 202. In one embodiment, the BB workflow engine 210 interacts with and manages BB reporting engine 220, and prediction engine 230 in order to provide a prediction related to the manufacturing environment 100. The BB workflow storage system 202 includes one or more BB workflows, each of which can be used (e.g., by the BB prediction component 120) to generate a prediction related to the manufacturing environment 100. The BB workflows can be created, edited and/or customized by a user and stored in the BB workflow storage system 202.

In one embodiment, the BB workflow engine 210 receives at least one BB workflow (e.g., from a user) or retrieves at least one BB workflow (e.g., from BB workflow storage system 202, etc.) and executes each of the blocks in an order specified within the BB workflow(s). As mentioned above, each block of the BB workflow(s) specifies one or more operations that are performed (e.g., by one of the BB reporting engine 220, prediction engine 230, etc.) when the BB workflow engine 210 executes the respective block. Examples of operations that can be included within the BB workflow(s) include, but are not limited to, retrieving data about the manufacturing facility, transforming and manipulating the data, generating a prediction based on the data, making the prediction available to one or more requestors, saving information about the state of the manufacturing facility, performing error checking on the prediction and data, reporting the error to a user, etc. In this manner, the BB workflow engine 210 can control the sequence of operations that the BB prediction component 120 performs to provide predictions.

According to various embodiments, depending on the blocks specified in the BB workflow(s), the BB prediction component 120 can use one of the BB workflow engine 210, BB reporting engine 220, or prediction engine 230 to execute the respective block. For example, in one embodiment, the BB prediction component 120 can extract, via the BB reporting engine 220, data about the manufacturing environment 100 from the factory storage system 140. In some embodiments, the BB reporting engine 220 can query other systems and/or web services (e.g., using representational state transfer (REST), or some other communication protocol) for data about the manufacturing environment 100. Such data can include, for example, descriptions of equipment in the manufacturing environment 100, capabilities of different pieces of equipment, current state of equipment, what product is currently being processed by equipment, characteristics of the product, and the like.

Upon extracting the information, the BB prediction component 120 can use the BB reporting engine 220 to perform one or more transformations or manipulations on the extracted data. For example, the data extracted from factory storage system 140 may be in a format (or schema) that is specific or proprietary to the manufacturing environment 100 and not compatible with the BB prediction component 120. In these situations, the BB reporting engine 220 can convert the data from the proprietary format to a common schema that is compatible with the rest of the BB prediction component 120. In addition, the BB reporting engine 220 can evaluate the data in the proprietary format and common schema data for errors, and if errors are detected, correct the errors in the common schema data, and report the errors to a user (e.g., via email, storing in a database, etc.). In some embodiments, the BB reporting engine 220 can use at least one BB sub-rule and/or report within the BB RR storage system 250 to perform the data extraction, data conversion, error checking, etc. For example, the BB reports and/or rules can be created by a user and allow the user to configure, without the need to understand or write any code, the operations for each block in the BB workflow(s). In this manner, the techniques presented herein allow the user to customize the operations for the blocks in the prediction workflow that may be used to extract data, convert the data, and/or perform error checking.

In one embodiment, once the BB reporting engine 220 converts the extracted data into a common prediction schema and performs error checking on the common schema data, the BB workflow engine 210 may evaluate the data and generate a prediction related to the manufacturing environment 100. In some embodiments, the BB workflow engine 210 can use the prediction engine 230 to generate the predictions. For example, the BB workflow engine 210 can use the prediction engine 230 to perform operations related to generating predictions (e.g., using simulation, forecasting, statistical prediction, trend analysis, machine learning, queuing theory, or calculations). Note that, although the prediction engine 230 and BB reporting engine 220 are shown within the BB prediction component 120, in some embodiments, the prediction engine 230 and/or BB reporting engine 220 can be external to the BB prediction component 120.

The prediction engine 230 can be configured with one or more BB rules and/or reports created by a user and stored in the BB report and rules (RR) storage system 250. One or more BB reports can be used to setup a predictive model within prediction engine 230, determine constraints for the predictive model, convert data into a format understood by the prediction engine 230, etc. In addition, one or more BB rules (created by a user) can be used to determine which constraints will govern the predictive model, process the results of the prediction engine 230 that runs the model (e.g., which can include converting the results back to the common schema, etc.), and the like.

In one embodiment, once the prediction engine 230 determines the predictions, the prediction engine 230 provides the predictions to the BB workflow engine 210, which can publish the predictions or a schedule based on the predictions (e.g., determined by scheduling system 180, which may be provided with the predictions) to at least one of the dispatchers 160 or external storage system 170. In one embodiment, the BB workflow engine 210 can use at least one BB report and/or rule (e.g., within BB RR storage system 250) to process the prediction (e.g., converting the prediction to a format used by the manufacturing environment, etc.) before publishing the prediction to at least one of the dispatchers 160, scheduling system 180, or external storage system 170.

As mentioned above, the techniques presented herein also allow the BB prediction component 120 to evaluate generated predictions and perform troubleshooting in the event of any problems or errors. For example, in one embodiment, upon receiving the input and output data associated with the execution of each block in the BB workflow, the BB workflow engine 210 writes some or all of the input and/or output data for one or more blocks to the run stores 150. For example, for each prediction run, the BB workflow engine 210 can write any one of the extracted data, common schema data, predictive model and its results, prediction input and output, published predictions, and other information associated with blocks in the BB workflow to the run stores. In one embodiment, the BB workflow engine 210 writes to a file system directory (within the run stores 150) that is unique to each predicting run. In this manner, the BB prediction component 120 is able to reproduce the state of the manufacturing environment 100 for one or more steps of a prediction run. The BB prediction component 120, for example, can evaluate the data associated with one or more steps via the BB reporting engine 220 (and via one or more BB reports and rules) to determine any changes that need to be made to the prediction process. As such, the techniques presented herein allow for retrospective debugging, since all the data associated with one or more steps of a prediction run can be made available via the run stores 150.

Note, however, that FIG. 2 illustrates merely one possible arrangement of the BB prediction component 120. More generally, one of ordinary skill in the art will recognize that other embodiments of the BB prediction component 120 can also be configured to implement predictions in accordance with the techniques presented herein. For example, although the BB workflow engine 210, BB reporting engine 220, and prediction engine 230 are shown as separate entities, in other embodiments, these components could be included as part of one computing system.

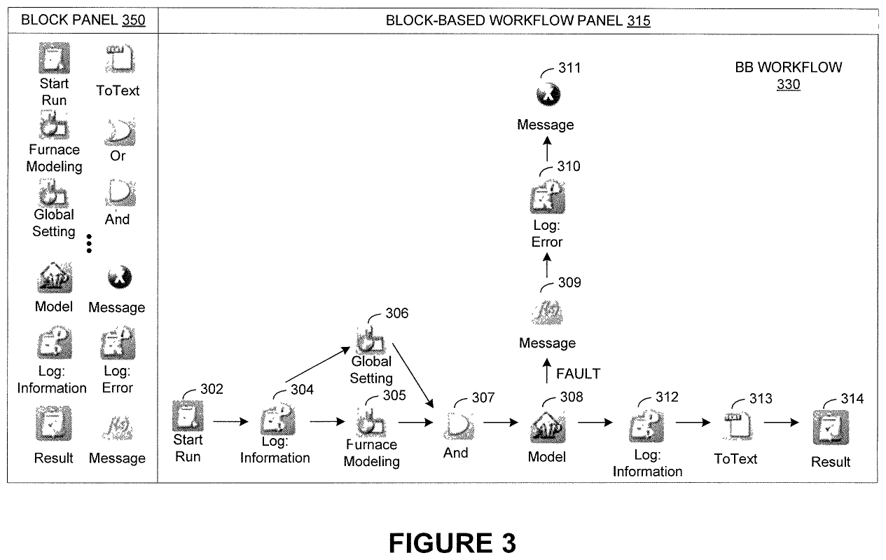

FIG. 3 illustrates a user interface 300 with a BB workflow 330 that can be used to generate predictions related to a manufacturing environment, according to one embodiment. As shown, the user interface 300 includes a block panel 350 and a BB workflow panel 315. The block panel 350 includes a plurality of blocks that allow a user to customize operations within a BB workflow to generate a prediction related to a manufacturing environment. In this embodiment, each block is depicted as a small image characteristic of the block's function. However, note that, in general, the blocks can be depicted in other manners (e.g., size, shape, color, etc.). BB workflow panel 315 illustrates one example of a BB workflow 330. Note that, for the sake of convenience, only a portion of the BB workflow 330 is illustrated. More generally, those of ordinary skill in the art will recognize that a user can create and/or modify any BB workflow to include any number of blocks.

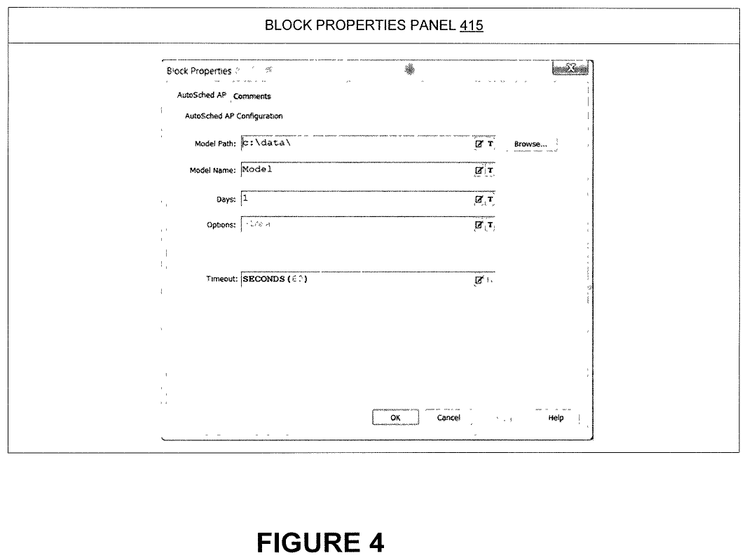

In one embodiment, the user interface (UI) 300 is a graphical user interface (GUI) that allows the user to drag and drop blocks from block panel 350 into BB workflow panel 315. The user can arrange the blocks (in BB workflow panel 315) in any order or configuration, which allows the user to quickly adapt the prediction system to any changes within the manufacturing environment, without understanding or writing any code. For example, each block in the block panel 350 is a logical abstraction that represents an operation or a series of operations that can be performed related to generating a prediction. In one embodiment, the UI 300 allows the user to specify one or more properties for each block in the workflow panel 315. The one or more properties can specify a data source for the block, timing of one or more operations associated with the block, and/or other criteria associated with performing the operations associated with the block. An example of a block properties panel is shown below in FIG. 4. In one embodiment, the operations and/or the properties for each block in the BB workflow panel 315 can be stored in one or more block definition files that the BB prediction component can access in order to execute each block.

In one embodiment, once the BB prediction component 120 executes the BB workflow, the BB prediction component 120 reads the definition files, converts the operations listed in the files into a low-level script that the BB prediction component 120 executes to generate a prediction. The BB prediction component 120 can provide the prediction to other devices or components (e.g., scheduling system 180), evaluate the prediction for errors, or provide the prediction to anyone that requests the prediction.

In another embodiment, once the BB prediction component 120 retrieves at least one BB workflow from the BB workflow storage system 202, the BB prediction component 120 reads and parses the BB workflow to determine the type of blocks within the BB workflow. The BB prediction component 120 can access one or more block definitions corresponding to each type of block within the BB workflow. The BB prediction component 120 can execute the BB workflow based on the block definitions and/or the properties of the blocks in the BB workflow. For example, in one implementation, the BB prediction component 120 can determine at least one function to call to perform the operations in the block (e.g., execute the block) based on the block type and/or properties of the block. The BB prediction component 120 can then execute the BB workflow by performing the set of operations using the determined functions.

In this particular embodiment, this portion of the BB workflow 330 includes blocks 302-314, which together specify a sequence of operations which, when executed by the BB prediction component 120, can result in generation of a prediction related to a manufacturing environment. Specifically, block 302 defines a start operation that triggers the initial execution of the BB workflow 330. Block 304 defines an operation for writing results of the start operation to a log file. Blocks 305 and 306 are connected by an “and” block 307, which means that the operations in both blocks 305 and 306 are performed (e.g., simultaneously). Block 305 defines a furnace modeling operation that loads/collects customer data (e.g., data collected from one or more tools in the manufacturing environment) and creates or loads a prediction model based on the customer data. Block 306 defines global setting operation that modifies one or more settings associated with the prediction process.

Block 308 defines an operation that executes the prediction model created at block 305 in order to generate one or more predictions related to the manufacturing environment. Blocks 309-311 represent operations for handling errors related to executing the operation defined by block 308, such as a “FAULT” event (e.g., involving notifying a user and/or other entities of the error via messages, while logging results of operations).

Block 312 defines an operation for writing the results of executing the operation defined by block 308 to a log file. Block 313 defines an operation for outputting results of previous blocks (e.g., predictions determined by the prediction model) to a text file. Block 314 defines an operation for outputting a result, such as one or more predictions determined by the prediction model, such as publishing the result to one or more devices or components. In some embodiments, one or more of blocks 312-314 also define operations for post-processing the result to create input that is usable for other purposes, such as determining a schedule based on predictions.

Note that the BB workflow 330 depicted in FIG. 3 and described above represents merely one example of a sequence of blocks that can be configured, e.g., by a user without coding. In general, the techniques presented herein can be used to modify and/or customize a prediction system to any manufacturing environment.

It is noted that, while BB workflow 330 includes two separate blocks 305 and 308 for creating and executing the prediction model, these blocks may alternatively be combined into a single block that both creates and executes the prediction model.

FIG. 4 illustrates an example block properties panel 415 that can be used to configure a set of operations to be performed for a particular block in a BB workflow, according to one embodiment. For example, block properties panel 415 may be used to configure operations to be performed for block 305 or block 308 of BB workflow 330 in FIG. 3. In certain embodiments, block properties panel 415 is launched by a user interaction with a block, such as double-clicking on the block or right-clicking on the block and selecting a “block properties” menu item associated with the block.

Block properties panel 415 includes several properties that can be selected and/or modified by a user. For example, block properties panel 415 allows the user to specify a path for the prediction model, a name of the prediction model, a number of days (e.g., number of days in the future for which predictions should be determined by the prediction model, which may constitute a specified future time for predictions), other options (e.g., whether or not constraints are entered as literals), and a timeout period (e.g., number of seconds after which the operations defined by the block should be timed out).

Note that the block properties panel 415 depicted in FIG. 4 and described above represents merely one example of a block properties panel that can be configured, e.g., by a user without coding. Additional or different properties may also be included.

FIG. 5 is a flow diagram of a method 500 for executing a BB workflow to predict future stated of equipment and lots in a manufacturing environment, according to one embodiment. As shown, the method begins at block 502, where a BB prediction component 120 (e.g., as shown and described with respect to FIG. 1) receives a BB workflow (e.g., from a user). The BB workflow includes a plurality of blocks that specify a set of operations for that specify operations for generating predictions for a specified future time interval in a manufacturing environment. To perform the set of operations, at block 504, the BB prediction component 120 accesses block definitions corresponding to the plurality of blocks. At block 506, the BB prediction component 120 executes the BB workflow by performing the operations shown at steps 508, 510, and 512.

At step 508, the BB prediction component 120 extracts data (e.g., via the BB reporting engine) from the manufacturing environment. In one embodiment, the data includes device and/or current work-in-progress (WIP) data (e.g., from tools or equipment in the manufacturing environment) that describes a number of lots available for processing and/or one or more devices operating in the manufacturing environment. The data can include static data (e.g., equipment used by a source system, capability of different pieces of the equipment, etc.) and dynamic data (e.g., current equipment state, products being currently processed by equipment of a source system, the product characteristics, etc.). In some embodiments, the BB prediction component 120 can convert the data from a first schema (or format) used by the manufacturing environment to a second schema. The BB prediction component 120 can also evaluate the data in at least one of the first schema or second schema for errors, and report any errors to a user.

At step 510, the BB prediction component 120 determines, based on the extracted data, predictions related to the manufacturing environment for the specified future time interval. In one embodiment, the BB prediction component can employ a prediction model (configured with at least one BB report or rule) to determine the predictions. The predictions may relate to a future WIP and/or a future state of the equipment and/or lots in the manufacturing facility, the quantity and composition of the product that will be manufactured in the facility, the state of the operators (e.g., their location, whether they are working or idle), the estimated time a product will finish a given operation and/or be available for processing at a given step, the estimated time a preventative maintenance operation will be performed on equipment, or another aspect of the manufacturing environment.

At step 512, the BB prediction component 120 publishes the predictions to at least one component in the manufacturing environment. In one embodiment, the component comprises a scheduling component (e.g., scheduling system 180) that determines a schedule (e.g., including an allocation and processing order) based on the predictions. One or more devices may be automated within the manufacturing environment based on the determined allocation and the processing order. For example, as mentioned above, the determined allocation and processing order may be published to dispatchers 160 to automate the one or more devices. Additionally or alternatively, the BB prediction component 120 can write (or save) the predictions to one or more storage systems (e.g., such as external storage system 170, etc.) in the manufacturing environment.

FIG. 6 is a flow diagram of a method 600 for executing a block-based workflow to generate a prediction related to a manufacturing environment, according to one embodiment. As shown the method begins at block 602, where the BB prediction component 120 executes a BB workflow. For each block, the BB prediction component, at block 604, determines if the block is configured with a BB sub-rule or report (block 604). If so, the BB prediction component 120 evaluates, at block 606, the BB sub-rule or report to determine at least one operation to perform when executing the workflow block. After evaluating the BB sub-rule or report (or if the BB prediction component 120 determines the workflow block is not configured with a BB sub-rule or report), the BB prediction component 120 optionally saves, at block 608, the input to the workflow block to a file directory (e.g., such as in run stores 150). In one embodiment, the BB prediction component 120 can save some or all of the input from the workflow block to the file directory. In one embodiment, the BB prediction component 120 can determine to save none of the input from the workflow block to the file directory (e.g., in situations where the BB prediction component 120 can reproduce the state of the manufacturing environment without such data, etc.). At block 610, the BB prediction component 120 accesses a block definition corresponding to a type of the block in the BB workflow. At block 612, the BB prediction component 120 performs the operation(s) specified within the block based on the block definitions and one or more properties of the block. For example, as mentioned above, the BB prediction component 120 can determine at least one function to call in order to execute the workflow block, based on the block definition and/or one or more properties of the block. At block 614, the BB prediction component 120 optionally saves the output from the workflow block to the file directory. In one embodiment, the BB prediction component 120 can save some or all of the output from the workflow block to the file directory. In one embodiment, the BB prediction component can determine to save none of the output from the workflow block to the file directory (e.g., in situations where the BB prediction component 120 can reproduce the state of the manufacturing environment without such data, etc.). Doing so in this manner, allows the prediction system to reproduce the state of the manufacturing environment at each step of the prediction run, which can be used to troubleshoot the prediction process in the event of errors.

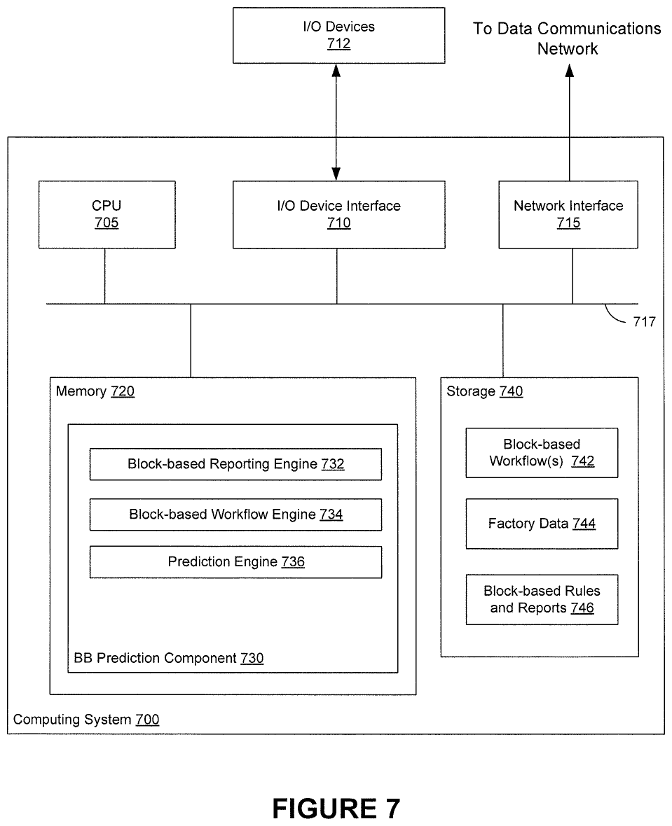

FIG. 7 illustrates a computing system 700 configured to execute a block-based workflow to generate a prediction related to a manufacturing environment, according to one embodiment. As shown the computing system 700 includes, without limitation, a central processing unit (CPU) 705, a network interface 715, a memory 720, and storage 740, each connected to a bus 717. The computing system 700 may also include an I/O device interface 710 connecting I/O devices 712 (e.g., keyboard, mouse, and display devices) to the computing system 700. Further, in context of this disclosure, the computing elements shown in the computing system 700 may correspond to a physical computing system (e.g., a system in a data center) or may be a virtual computing instance executing within a computing cloud.

The CPU 705 retrieves and executes programming instructions stored in the memory 720 as well as stores and retrieves application data residing in the memory 720. The interconnect or bus 717 is used to transmit programming instructions and application data between CPU 705, I/O devices interface 710, storage 740, network interface 715, and memory 720. Note, CPU 705 is included to be representative of a single CPU, multiple CPUs, a single CPU having multiple processing cores, and the like. Memory 720 is generally included to be representative of a random access memory. Storage 740 may be a disk drive storage device. Although shown as a single unit, storage 740 may be a combination of fixed and/or removable storage devices, such as fixed disc drives, removable memory cards, or optical storage, network attached storage (NAS), or a storage area-network (SAN).

Illustratively, the memory 720 includes a BB prediction component 730, which includes BB reporting engine 732, a BB workflow engine 734, and prediction engine 736. The storage 740 includes BB workflow(s) 742, factory data 744 and BB rules and reports 746. Further, although not shown, memory 720 can also include dispatchers 160, scheduling system 180, etc. In one embodiment, the BB workflow engine 734 executes each of the blocks in BB workflow(s) 742. For example, as mentioned above, each block in the BB workflow(s) 742 can specify one or more operations to be performed when executing each block. Further, one or more operations can be configured with one or more BB reports and rules (e.g., stored in BB rules and reports 746). As also mentioned above, the BB workflow engine 734 can further interact with the BB reporting engine 732 and the prediction engine 736 when executing the workflow blocks.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, C #, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, executed in parallel, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method for executing a block-based (BB) workflow to generate a plurality of predictions related to a semiconductor manufacturing environment, comprising:
receiving at least one BB workflow comprising a plurality of blocks, wherein the plurality of blocks specify a set of operations for generating the plurality of predictions relating to a specified future time interval;
accessing a plurality of block definitions corresponding to the plurality of blocks; and
executing the at least one BB workflow by performing the set of operations based on the plurality of block definitions, comprising:
extracting data from the semiconductor manufacturing environment, wherein the data comprises both static data and dynamic data related to equipment in the manufacturing environment;
determining, based on the extracted data, the plurality of predictions, wherein each of the plurality of predictions relates to the manufacturing environment and the specified future time interval; and
publishing the plurality of predictions to at least one component in the semiconductor manufacturing environment, wherein the plurality of predictions are used to determine a manufacturing schedule for the semiconductor manufacturing environment.

2. The method of claim 1, wherein executing the at least one BB workflow further comprises: transforming the plurality of predictions into a format compatible with the at least one component, wherein the plurality of predictions are published to the at least one component in the format.

3. The method of claim 1, wherein the manufacturing schedule comprises an allocation of a number of lots to a subset of the equipment in the semiconductor manufacturing environment, and a processing order in which the lots should be processed by the subset of the equipment, and wherein the subset of the equipment in the semiconductor manufacturing environment is automated based on the allocation and the processing order.

4. The method of claim 1, further comprising evaluating, for one or more blocks of the at least one BB workflow, at least one BB sub-rule or report to determine at least one operation of the set of operations to perform.

5. The method of claim 1, wherein receiving the at least one BB workflow comprises: receiving input from a user, via a user interface, that identifies the plurality of blocks.

6. The method of claim 5, wherein the input further identifies one or more links connecting the plurality of blocks.

7. The method of claim 1, wherein executing the at least one BB workflow further comprises:
writing at least one of the extracted data or the plurality of predictions to a storage system in the semiconductor manufacturing environment; and
upon determining an error related to determining the plurality of predictions, reporting the error to a user.

8. The method of claim 1, wherein the plurality of predictions comprise one of: a future work-in-progress (WIP), a future state of a lot in the manufacturing environment; a future state of a device in the manufacturing environment, a quantity of a product manufactured in the manufacturing environment, a composition of a product manufactured in the manufacturing environment, an estimated time that an operation will be completed in the manufacturing environment, and an estimated time that a maintenance operation will be performed in the manufacturing environment.

9. A non-transitory computer-readable medium containing computer program code that, when executed by a processor, performs an operation for executing a block-based (BB) workflow to generate a plurality of predictions related to a semiconductor manufacturing environment, the operation comprising:
receiving at least one BB workflow comprising a plurality of blocks, wherein the plurality of blocks specify a set of operations for generating the plurality of predictions relating to a specified future time interval;
accessing a plurality of block definitions corresponding to the plurality of blocks; and
executing the at least one BB workflow by performing the set of operations based on the plurality of block definitions, comprising:
extracting data from the semiconductor manufacturing environment, wherein the data comprises both static data and dynamic data related to equipment in the manufacturing environment;
determining, based on the extracted data, the plurality of predictions, wherein each of the plurality of predictions relates to the manufacturing environment and the specified future time interval; and
publishing the plurality of predictions to at least one component in the semiconductor manufacturing environment, wherein the plurality of predictions are used to determine a manufacturing schedule for the semiconductor manufacturing environment.

10. The non-transitory computer-readable medium of claim 9, wherein executing the at least one BB workflow further comprises: transforming the plurality of predictions into a format compatible with the at least one component, wherein the plurality of predictions are published to the at least one component in the format.

11. The non-transitory computer-readable medium of claim 9, wherein the manufacturing schedule comprises an allocation of a number of lots to a subset of the equipment in the semiconductor manufacturing environment, and a processing order in which the lots should be processed by the subset of the equipment, and wherein the subset of the equipment in the semiconductor manufacturing environment is automated based on the allocation and the processing order.

12. The non-transitory computer-readable medium of claim 9, wherein the operation further comprises evaluating, for one or more blocks of the at least one BB workflow, at least one BB sub-rule or report to determine at least one operation of the set of operations to perform.

13. The non-transitory computer-readable medium of claim 9, wherein receiving the at least one BB workflow comprises: receiving input from a user, via a user interface, that identifies the plurality of blocks.

14. The non-transitory computer-readable medium of claim 13, wherein the input further identifies one or more links connecting the plurality of blocks.

15. The non-transitory computer-readable medium of claim 9, wherein executing the at least one BB workflow further comprises:
writing at least one of the extracted data or the plurality of predictions to a storage system in the semiconductor manufacturing environment; and
upon determining an error related to determining the plurality of predictions, reporting the error to a user.

16. The non-transitory computer-readable medium of claim 9, wherein the plurality of predictions comprise one of: a future work-in-progress (WIP), a future state of a lot in the manufacturing environment; a future state of a device in the manufacturing environment, a quantity of a product manufactured in the manufacturing environment, a composition of a product manufactured in the manufacturing environment, an estimated time that an operation will be completed in the manufacturing environment, and an estimated time that a maintenance operation will be performed in the manufacturing environment.

17. A system comprising:
at least one processor; and
a memory containing a program that, when executed by the at least one processor, performs an operation for executing a block-based (BB) workflow to generate a plurality of predictions related to a semiconductor manufacturing environment, the operation comprising:
receiving at least one BB workflow comprising a plurality of blocks, wherein the plurality of blocks specify a set of operations for generating the plurality of predictions relating to a specified future time interval;
accessing a plurality of block definitions corresponding to the plurality of blocks; and
executing the at least one BB workflow by performing the set of operations based on the plurality of block definitions, comprising:
extracting data from the semiconductor manufacturing environment, wherein the data comprises both static data and dynamic data related to equipment in the manufacturing environment;
determining, based on the extracted data, the plurality of predictions, wherein each of the plurality of predictions relates to the manufacturing environment and the specified future time interval; and
publishing the plurality of predictions to at least one component in the semiconductor manufacturing environment, wherein the plurality of predictions are used to determine a manufacturing schedule for the semiconductor manufacturing environment.

18. The system of claim 17, wherein executing the at least one BB workflow further comprises: transforming the plurality of predictions into a format compatible with the at least one component, wherein the plurality of predictions are published to the at least one component in the format.

19. The system of claim 17, wherein the manufacturing schedule comprises an allocation of a number of lots to a subset of the equipment in the semiconductor manufacturing environment, and a processing order in which the lots should be processed by the subset of the equipment, and wherein the subset of the equipment in the semiconductor manufacturing environment is automated based on the allocation and the processing order.

20. The system of claim 17, wherein the operation further comprises evaluating, for one or more blocks of the at least one BB workflow, at least one BB sub-rule or report to determine at least one operation of the set of operations to perform.
